(19) United States
(12) Patent Application Publication
(10) Pub. No.: US 2025/0215523 A1
(43) Pub. Date: Jul. 3, 2025

(54) Improved Systems And Methods For Metal Recovery From Lithium Ion Batteries

(71) Applicant: Aqua Metals Inc., Reno, NV (US)

(72) Inventors: Brian James Dougherty, Newtown (NZ); James Kenney, Reno, NV (US); Mark Strauss, Reno, NV (US)

(73) Assignee: Aqua Metals Inc., Reno, NV (US)

(21) Appl. No.: 18/848,476

(22) PCT Filed: Mar. 16, 2023
(86) PCT No.: PCT/US2023/015405

§ 371 Date: Sep. 18, 2024

Related U.S. Application Data
(60) Provisional application No. 63/321,897, filed on Mar. 21, 2022.

(51) Int. Cl. C22B 7/00; C01D 15/02; C22B 3/00; C22B 3/26; C22B 3/42; C22B 3/44; C22B 21/00; C22B 26/12; C22B 47/00; C25C 1/02; C25C 1/08; H01M 10/54

(52) U.S. Cl. CPC C22B 7/007; C01D 15/02; C22B 3/26; C22B 3/42; C22B 3/44; C22B 21/0023; C22B 23/043; C22B 23/0453; C22B 26/12; C22B 47/00; C25C 1/02; C25C 1/08; H01M 10/54

(57) ABSTRACT

Black mass from disused lithium batteries is leached for recovery of various metals in a process that includes precipitation, solvent exchange, ion exchange, and salt splitting to create multiple product streams for recovery of pure value products. Most typically, the process is a closed-loop process and allows for production of metallic cobalt and nickel, EMD, and a high purity lithium hydroxide or carbonate product with minimal generation of waste streams.

This application claims priority to our copending U.S. Provisional Patent Application with the Ser. No. 63/321,897, which was filed Mar. 21, 2022, and which is incorporated by reference herein.

### FIELD OF THE INVENTION

The field of the invention is metal recovery from lithium batteries, and especially as it relates to recovery of lithium, cobalt, copper, manganese, and nickel from black mass.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The production and usage of lithium ion batteries has worldwide dramatically increased over the last decade, placing a significant strain on supply for the raw materials needed for the manufacture of such batteries. Moreover, for at least the next twenty years a further increase in demand is projected. Unfortunately, the raw material sourcing and processing is almost exclusively based on foreign (non-US) countries, exposing the US economy to significant supply and price vulnerability.

While lead acid battery recycling has become an integral part of re-supplying lead for production of new lead acid batteries, recycling of lithium ion batteries is significantly less well developed. Among other factors, there is a relatively large diversity of form factors (such as battery packs, modules, cylindrical cells, prismatic cells, pouch cells, etc.), available materials (such as defective cells, metal scraps, slurries, and powders), and cathode chemistries (such as lithiated cobalt oxide, lithiated nickel-cobalt-aluminum oxide, lithiated nickel-cobalt-manganese oxide, lithiated nickel-cobalt-manganese-aluminum oxide, lithiated nickel-oxide, and lithiated manganese-oxide, etc.). Moreover, the relative amounts of transition metals used in lithium-based batteries vary substantially among different lithium ion batteries, which typically compounds recovery of lithium and other valuable metals from lithium ion batteries. In addition, similar supply challenges exist for these valuable metals such as nickel, cobalt, and manganese, and many lithium recovery processes entirely fail to address recycling of these elements. An overview of currently known lithium ion battery processes is found elsewhere (see Batteries 2019, 5, 68; doi:10.3390/batteries5040068).

Among various methods of recovering valuable metals and metal salts from lithium battery waste materials, solvent based processes are frequently employed. For example, US 2021/0317547 teaches hydrometallurgical methods for recovering metals from spent lithium batteries in which an aqueous hydrobromic acid leach solution contacts electrode material for extraction of the metals. The so obtained extraction liquid is then subjected to precipitation and/or cathodic electrodeposition to obtain metals of interest. In another known process, as disclosed in US 2021/0344058, CO₂ is used as a leaching solution and the leachate is then subjected to precipitation and roasting to yield cobalt and lithium materials. In still further known methods, metal sulfates are obtained from a mother liquor for further processing as is taught in US 2022/0009793. Similarly, US 2022/0013815 teaches use of sulfuric acid as a leaching fluid in which cobalt, nickel, and manganese oxides are dissolved using reduction by gaseous sulfur dioxide.

In many such known recovery methods, additional processes are often required to obtain the metals or metal salts in a desirable purity and yield. For example, cobalt can be electrolytically formed in an electrochemical process as is described, for example, in Hydrometallurgy 178 (2018) 19-29. Metallic manganese and electrolytic manganese dioxide can be simultaneously produced in an anion exchange membrane reactor as is described in the Bulletin Of The Georgian National Academy Of Sciences, vol. 2, no. 4, 2008. In still further known processes, lithium is recovered from a leachate that is treated using an electrodialyzer as taught in JP 2012/234732. Similarly, lithium hydroxide is prepared from a lithium sulfate solution using an electrodialysis process as described in WO 2013/159194. Unfortunately, all or almost all of these known processes will require complex operation to produce distinct product streams, require subsequent processing of the product streams, and are typically not suitable for a closed-loop process to so reduce waste streams. Moreover, a large number of the known processes for metal recovery will recover the metals in a salt form that needs further processing into the corresponding metals.

In an effort to simplify operation, a sequential solvent extraction process may be used as described in US 2022/0205064. While at least conceptually more simple, various difficulties nevertheless remain. Among other issues, such sequential solvent extraction produces numerous liquid streams that require complex handling and coordination. Moreover, in most cases such sequential solvent stripping will not allow for an integrated process in which solvents (and especially the leach solution) can be recycled. In addition, the so recovered metals are typically formed as metal salts that will require further processing to the corresponding pure non-lithium metals.

Thus, even though various systems and methods of metal recovery from lithium batteries are known in the art, all or almost all of them suffer from several drawbacks. Therefore, there remains a need for improved methods for metal recovery from lithium batteries, and especially recovery of lithium, manganese, cobalt, copper, and nickel from black mass.

### SUMMARY OF THE INVENTION

The inventive subject matter is directed to various plant configurations, systems, and methods of metal recovery from disused lithium batteries in which multiple metals are recovered in a closed-loop process at high purity that allows for recycling of the leach solvent. Advantageously, contemplated systems and methods will reduce overall use of solvents and production of waste streams, while at the same time enabling a simple and effective process flow.

In one aspect of the inventive subject matter, the inventors contemplate a method of recovering metals from disused lithium batteries that includes a step of leaching from a battery material a plurality of distinct metals in ionic form with a leach solution to thereby produce a rich leach solution, another step of removing a first metal from the rich leach solution by electroplating to thereby produce a processed leach solution, a further step of removing a second metal from the rich leach solution by precipitation to thereby produce a further processed leach solution, a still further step of removing a third and optionally fourth metal from the further processed leach solution by solvent exchange to thereby produce a third and optionally fourth metal depleted leach solution, and yet another step of processing the third and optionally fourth metal depleted leach solution in a salt splitter unit to thereby regenerate at least some of the leach solution, to produce a metal hydroxide solution, and an effluent, wherein at least some of the metal hydroxide solution is used in the step of removing the second metal, and/or the step of removing a third and optionally fourth metal. Optionally, at least some of the effluent is used in the step of leaching.

In some embodiments, the battery material comprises black mass, and the plurality of distinct metals include lithium ions and further includes copper ions, aluminum ions, iron ions, cobalt ions, manganese ions, and/or nickel ions. In other embodiments, the battery material comprises processed black mass from which lithium ions were previously removed. In such case, the metal hydroxide solution is then sodium hydroxide, potassium hydroxide, or calcium hydroxide. Most typically, the leach solution is sulfuric acid or methane sulfonic acid, and may further contain a chelator (e.g., EDTA).

In certain aspects of the inventive subject matter, the first metal is copper and electroplating of the copper will typically use preferential electroplating of copper onto a flow-through cathode (e.g., graphite felt) and/or solid cathode (e.g. stainless steel or titanium), and/or the second metal will be aluminum and/or iron. In further aspects of the inventive subject matter, the third metal is cobalt and/or manganese. Preferably, the cobalt and/or the manganese are recovered from an organic solvent of the solvent exchange using an acid, and the cobalt and/or the manganese will be plated as metallic cobalt and as EMD in a single electrolyzer. Additionally, it is contemplated that the optional fourth metal is nickel, and that the fourth metal is removed in a separate solvent exchange. The nickel is then plated as metallic nickel in an electrolyzer. As will be readily appreciated, the solvent exchange uses a portion of the regenerated leach solution and/or the metal hydroxide solution from the salt splitter unit.

In yet further aspects of the inventive subject matter, the salt splitter unit will include at least two salt splitters. In a typical example, a first portion of the metal hydroxide solution of one of the at least two salt splitters is further processed to produce a LiOH or LiOH·H2O product or a lithium carbonate solution or a lithium carbonate precipitate, and/or a second portion of the metal hydroxide solution is used in the step of leaching, and/or the step of removing the second metal. The second portion of the metal hydroxide solution may also be used in the step of removing the third and optionally fourth metal.

Where desired, contemplated systems may further comprise an ion exchange resin or chelating resin to remove metal ion impurities from the third and optionally fourth metal depleted leach solution before feeding the third and optionally fourth metal depleted leach solution into the salt splitter unit.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an exemplary and simplified schematic process flow for metal recovery from black mass according to the inventive subject matter.

FIG. 2 is a more detailed exemplary process flow diagram for metal recovery from black mass according to the inventive subject matter.

### DETAILED DESCRIPTION

The inventors have discovered various systems and methods of metal recovery from lithium batteries, and especially from black mass of a lithium battery in which a leachate is subjected to a closed-loop process that allows for recovery of a variety of valuable metals such as copper, cobalt, manganese, nickel, and lithium using precipitation, solvent extraction, and salt splitting. Advantageously, contemplated systems and methods presented herein will not only produce high purity lithium hydroxide, but also allow for the production of metallic nickel, cobalt, and electrolytic manganese dioxide (EMD). Preferably, cobalt and EMD are produced in the same electrolyzer, and nickel in a separate electrolyzer, while two or more salt splitters produce lithium hydroxide at different sulfate content to so allow for a high purity lithium hydroxide product and lithium recycle streams for pH control and/or leaching. As will be readily appreciated, the salt splitters will also provide an acidic solution that is then used in the leach circuit to so close the loop in the process.

Therefore, viewed from a different perspective, contemplated systems and processes presented herein incorporate into a single electrolyzer plating of cobalt and manganese dioxide, recycle acid and base (lithium hydroxide) within the process of plating non-lithium raw metals (cobalt and nickel), thereby avoiding formation of mixed hydroxides and minimizing cost and raw material requirements. Most typically, a 2- or 3-stage salt splitting cell arrangement is used. Still further, it should be recognized that contemplated systems and processes can be readily adapted to black mass that contains little or no lithium by using sodium, potassium, ammonium, and/or calcium hydroxide in place of lithium hydroxide.

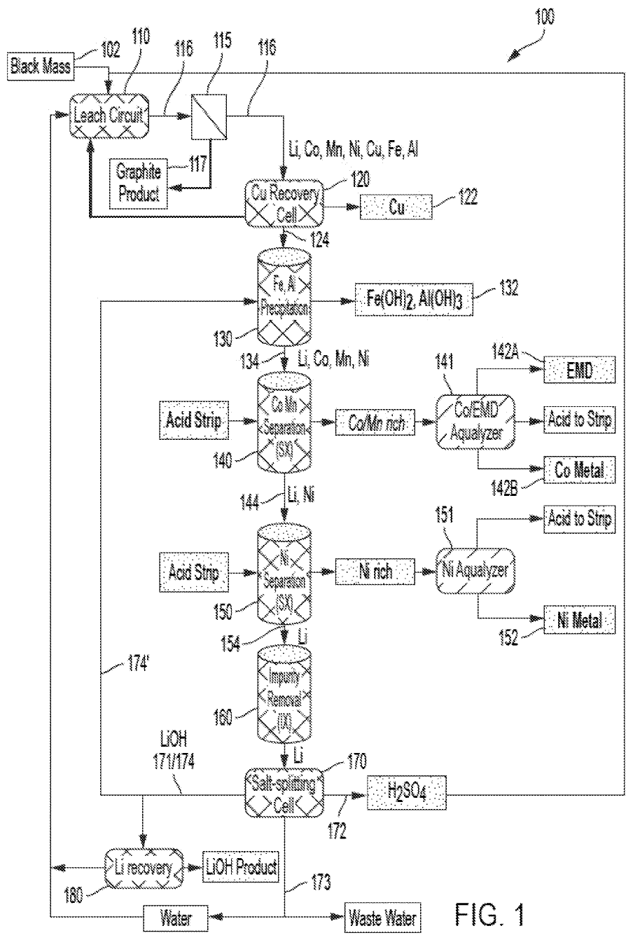

For example, and with reference to FIG. 1, an exemplary overall process 100 may be implemented in which electrode active material (“black mass”) 102 is used as a feedstock. In most cases, the black mass is obtained from shredded disused lithium batteries and typically contains significant quantities of cobalt, nickel, copper, lithium, manganese, aluminum, and graphite. As noted above, however, it should be appreciated that black mass from which at least some (e.g., at least 50%, or at least 70%, or at least 80%, or at least 90%) lithium has been removed is also deemed a suitable starting material. It is further preferred that the black mass will have already been processed to remove plastic components, but further or additional plastic removal is also contemplated. While not limiting to the inventive subject matter, it is also preferred that the black mass will be dry (or is dried) with a residual water content of no more than 5 wt %, or no more than 4 wt %, or no more than 3 wt %, or no more than 2 wt %, or no more than 1 wt %.

With further reference to FIG. 1, the dry/dried black mass is fed to a leaching tank 110, where the black mass is slurried with a leaching solution. Most preferably, the leaching solution will be sulfuric acid, methanesulfonic acid (MSA), hydrochloric acid, etc. or a combination thereof and may include disodium EDTA. The concentration of the acid will typically be between 0.5 M and 6 M, and the particular concentration will be at least in part a function of the specific acid that is used. For example, a preferred range for sulfuric acid will be 1.5-2.5 M, due to solubility limitations of Li₂SO₄ (about 3.2M) and Co (about 2.4M). On the other hand, where MSA is used, a preferred range will be 4-6 M as MSA is monoprotic and Li-methane sulfonate is significantly more soluble than Li₂SO₄. In general, sulfuric acid, methanesulfonic acid and disodium EDTA are preferred leachants. In some embodiments, methanesulfonic and (maybe) disodium EDTA can be used as the leachant.

It should also be noted that in at least some embodiments an additional reducing agent (e.g., iron (II) sulfate, hydrogen peroxide, etc.) will be used to reduce Co³⁺ to Co²⁺, and Mn⁴⁺ to Mn²⁺ into solution. In addition, it is contemplated that the pulp density of the leachate will preferably be between 5-300 grams/L. Regardless of the specific acid and feedstock used for leaching, it is contemplated that the leachate is concentrated in metal ions and will have a final pH of between 1-5. Where the pHis closer to 5, it is contemplated that such pH can be achieved in a two-stage leach, by mixing the leachate from a second stage with incoming material and by using the incoming material as pH modifier to get to a pH of about 5.

In some embodiments, an elevated temperature of 60-90° C. may be used during leaching, while in other embodiments, the temperature may be between 10-25° C., or between 20-35° C., or between 30-60° C. Leaching is typically performed in a batch process with duration of the leaching between about 5 minutes and 1 hour, or between 1-3 hours, or between 2-6 hours, or between 6-12 hours, or even longer. Upon conclusion of the leaching, the slurry from the leach tank is typically filtered in a filter unit 115, and non-dissolved residue 117 (chiefly graphite or anodic material, with trace amounts of undissolved metal cations) will be removed as filter cake. Where desired, a secondary leach circuit (not shown) may be added to increase recovery and to produce a graphite product with low metal content.

In at least some embodiments, the so obtained rich leach solution 116 will then be fed to a copper recovery cell 120 in which copper will be preferentially plated as metallic copper 122 and iron will be preferentially oxidized from Fe³⁺ to Fe²⁺. Most typically, the copper recovery cell 120 is configured as an electrochemical polishing reactor that has a high-surface area cathode (e.g., using a graphite felt as a flow-through cathode) at which the electrode potential is controlled to preferentially reduce copper. An exemplary configuration for such polishing reactor suitable for use herein is described in US 2022/0275527, which is incorporated by reference herein. As will be readily appreciated, the polishing reactor will be operated at a current low enough to remove most copper present in the leachate without plating significant quantities of other plateable metals such as cobalt or nickel. Moreover, while a flow through cathode with graphite felt is contemplated above, it should be appreciated that various other cathode materials, including stainless steel or titanium, are also deemed suitable for use herein.

Upon electrolytic copper removal, a portion of the so processed leach solution 124 will return to the leach tank 110 where the Fe²⁺ assists with the reduction of Co³⁺ to Co²⁺, and Mn⁴⁺ to Mn²⁺ into solution. In some embodiments the portion of processed leach solution returning to the leach tank is between 5 and 98%, while other embodiments the returned portion is between 6% and 20%. The other portion of the so processed leach solution 124 will be passed to a precipitation stage 130 where LiOH stream 174′ is added to raise the system pH to a value between 3 and 5 to thereby precipitate impurities such as aluminum and iron in form of the corresponding aluminum and iron hydroxides 132 without precipitating significant quantities (e.g., 3-5%, or 5-10%, or 10-15%, or 15-20%, or 20-30% of total metal content) of nickel, cobalt, manganese, and/or lithium. The aluminum and iron hydroxide precipitate 132 can then be removed via a filtration system and sold or disposed of. Most preferably, the LiOH solution 174′ used to adjust the pH is obtained from a downstream salt splitter as is described in more detail below.

After electrolytic removal of copper (via production of metallic copper) and aluminum and iron (via precipitation), the so further processed leach solution 134 is then fed to a metal separation stage. In at least some embodiments, the metal separation stage will include one or more solvent extraction stages in which the metal ions are selectively extracted by an organic reagent. For example, a first solvent extraction stage 140 will include a solvent extraction system in which cobalt 142B and manganese 142A are removed from the further processed leach solution 134. Among other choices, suitable organic solvents include Cyanex 272 and/or equivalent organic solvents. Most typically, the solvent will be diluted in an organic diluent (e.g., kerosene, heptane, ethanol, butane). As will be readily appreciated, the appropriate pH during solvent extraction will drive extraction efficiency of and selectivity for cobalt and manganese, and in at least some embodiments the pH is adjusted using addition of a LiOH solution or sulfuric acid solution obtained from a downstream salt splitting step as is discussed in more detail further below. Of course, it should be appreciated that the solvent extraction may be performed in one stage or multiple stages to achieve the required extraction efficiency and selectivity.

The so formed cobalt and manganese loaded organic phase from the first solvent extraction stage is then fed to a stripping stage where a concentrated (e.g., 1-6 M) acid solution will remove the metal ions. For example, H₂SO₄ can be used at a concentration of up to 6 M, while MSA can be used at a concentration of up to 5 M. Alternatively, the acid solution can also be other acids such as hydrochloric acid, nitric acid, or other inorganic acids. For recovery of metallic cobalt and EMD, the acid strip solution is fed to a single electrolyzer 141 or a series of electrolyzers in which cobalt and manganese compounds are (preferably separately) plated as value products. Thus, it should be recognized that metal recovery can be performed in a single electrolyzer that only plates cobalt, or to a joint cobalt/EMD electrolyzer, or a combination thereof depending on the composition of the electrolyzer feed and ratio of cobalt to manganese. In other embodiments, it is also contemplated that the ‘multi-metal electrolyzer’ can be used to recover nickel (along with EMD).

After passing through the first solvent exchange stage, the cobalt and manganese depleted leach solution can be fed to a second solvent extraction stage 150 where nickel and remaining cobalt are removed by one or more selective organic reagents. Among other suitable choices, contemplated organic reagents for the nickel removal include Cyanex 272, Versatic 10 Acid, Lix-84, D2EPHA, and/or other equivalent organic solvent. Once more, the appropriate pH during solvent extraction will drive extraction efficiency of and selectivity for nickel, and in at least some embodiments the pH is adjusted using addition of a LiOH or sulfuric acid solution obtained from a downstream salt splitting step as is discussed in more detail further below.

The so formed nickel loaded organic phase from the second solvent extraction stage is then fed to a stripping stage where a concentrated (e.g., 1-6 M) acid solution will remove the metal ions. For example, H₂SO₄ can be used at a concentration of up to 6 M, while MSA can be used at a concentration of up to 5 M. Alternatively, the acid solution can also be other acids such as hydrochloric acid, nitric acid, or other inorganic acids. For recovery of metallic nickel 152, the acid strip solution is fed to a single electrolyzer 151 or a series of electrolyzers in which nickel is plated as a value product.

After passage through the (preferably dual) solvent exchange system, the nickel depleted leach solution is now significantly depleted of metals other than lithium and the so obtained lithium (sulfate or methane sulfonate) rich leach solution is then fed to one or more salt-splitting cells 170 to recover the lithium as an alkaline LiOH solution 171/174 and to produce the leaching acid 172 (e.g., H₂SO₄ or MSA) that can then be routed to the start of the process. Lithium recovery unit 180 receives a portion of alkaline LiOH solution 171/174 and produces pure lithium product. As needed or desired, an ion exchange system 160 can be employed upstream of the salt splitting cell 170 to remove any cationic metal impurities such as Zn, Cu, Fe, Al, Co, Ni, Mn cations (e.g., using a chelating resin or DOWEX 4195 resin). As will be readily appreciated, contemplated systems and methods may employ multiple salt splitter stages, and two or three stages are especially contemplated.

For example, in one embodiment the salt splitting will occur in two or three stages where the first stage will produce the highest concentration of lithium hydroxide at the lowest residual sulfate (or methane sulfonate where the leach solution is MSA) concentration. Most preferably, the LiOH solution produced in this salt splitter will be removed from the system and further processed to generate the lithium value product. For example, water may be evaporated to produce a LiOH or LiOH·H₂O product. Alternatively, the LiOH solution may be carbonated with gaseous CO₂ to produce lithium carbonate or precipitated using soda ash at elevated temperature to lithium carbonate. As already noted, the H₂SO₄ produced from this first stage will preferably be recycled back into the process, either to the solvent extraction acid stripping system(s) and/or into the leaching system.

The second stage will have a lower concentration of lithium species. The LiOH solution produced by the second stage will be at a lower concentration and will be sent to the first salt splitting cell to increase the concentration. Since the process will require a higher quantity of pure LiOH, two stages are used for pure LiOH production, while only one stage is used for pure H₂SO₄ (or MSA) production. However, it is noted that 100% (less any bleed) of the acid will preferably be recycled into the process somewhere, while about 66% of the LiOH will also be recycled into the process. Therefore, the volumes of these recycled streams will need to match what is used in the leach and solvent exchange circuits, and this will ultimately determine the LiOH concentrations produced in the salt-splitting cell. In some embodiments of this second stage salt splitting cell will not be needed.

The third stage will have the lowest concentration of lithium species and the highest lithium sulfate (or lithium methanesulfonate) concentration in the hydroxide and acid streams. The LiOH solution produced here may have some contaminants and will be recycled into the process for pH control. The H₂SO₄ (or MSA) and lithium sulfate containing effluent from this third stage will be recycled in the process into the leach circuit. The effluent stream from the final salt splitting cell (i.e., dilute lithium sulfate), may be (a) fully or partly recycled to the H₂SO₄— or MSA-producing chamber of the third stage salt-splitting cell; (b) fully or partially recycled to the LiOH-producing chamber of the third stage salt-splitting cell; (c) both (a) and (b); or (d) a part of this stream may go to a waste water treatment system if impurities have built up to a sufficiently high level.

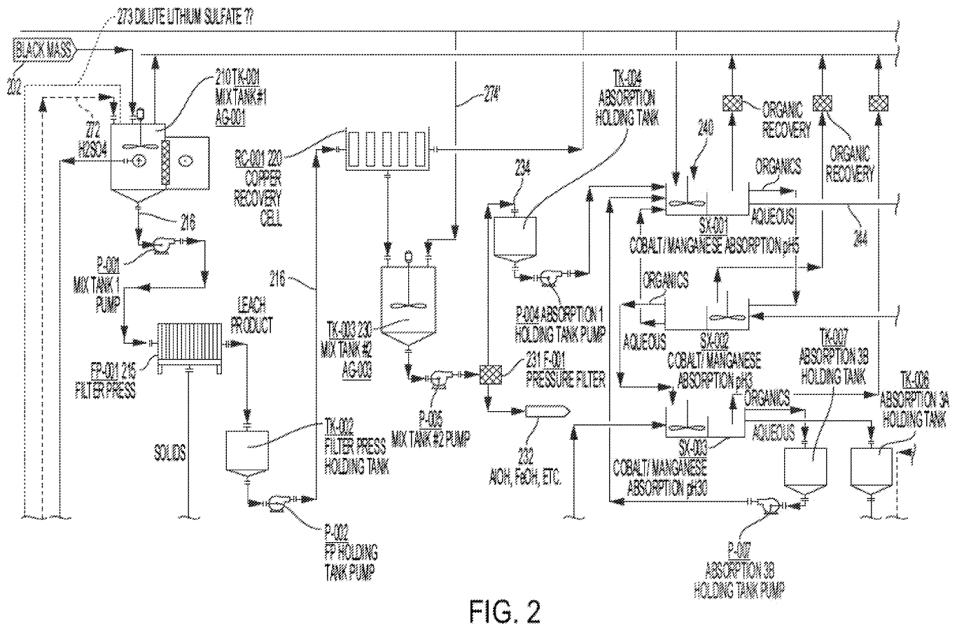

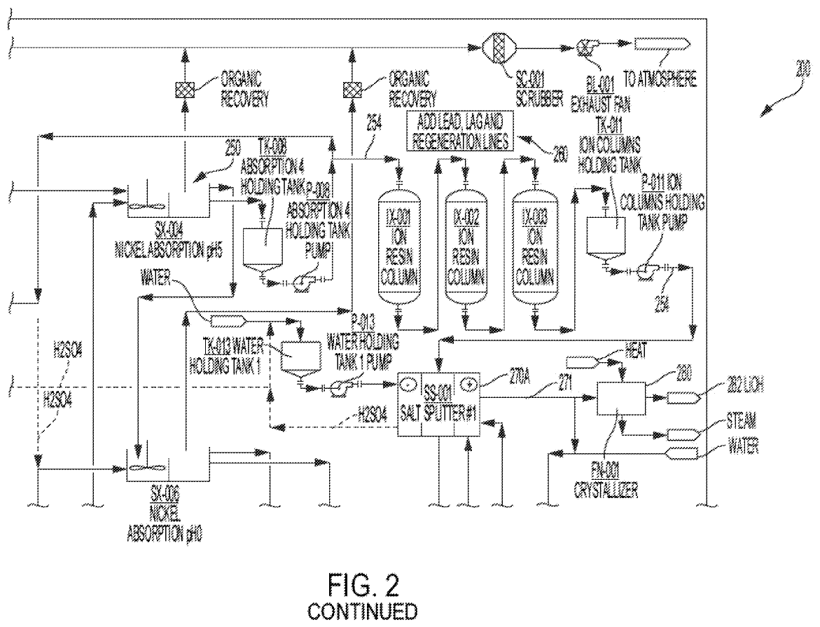

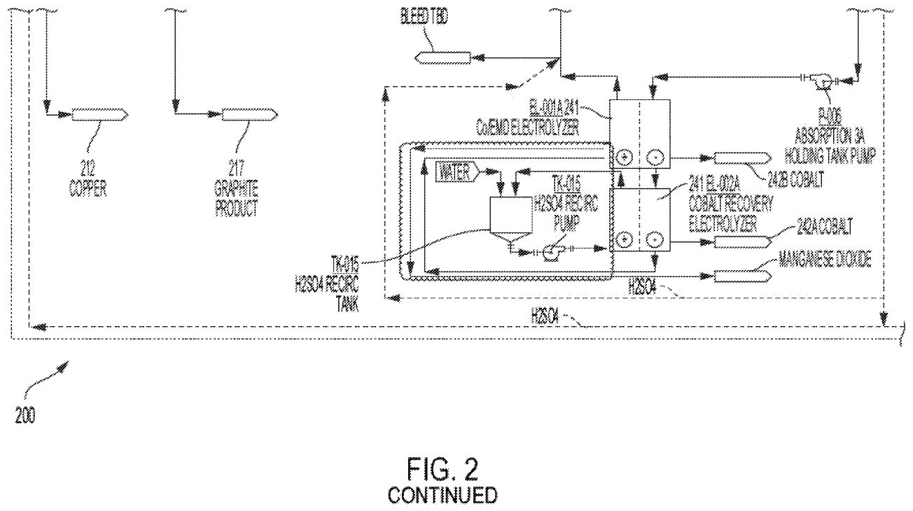

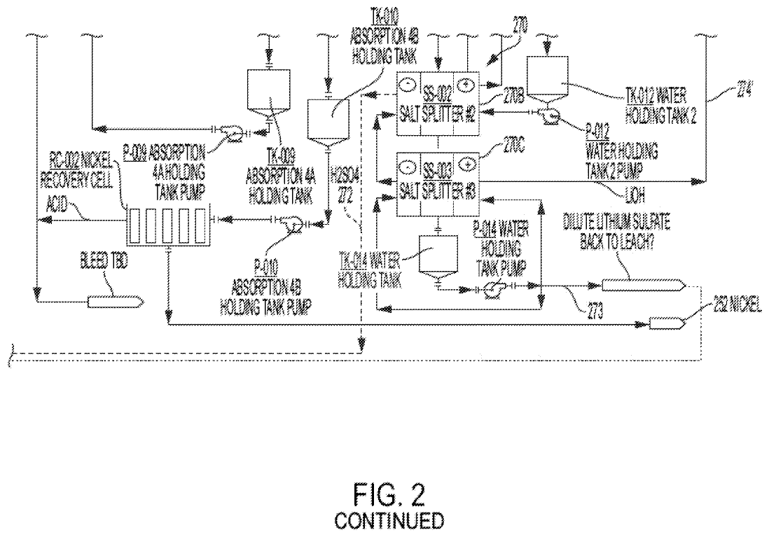

FIG. 2 depicts a more detailed process flow diagram of a processing plant 200 in which the black mass 202 is treated in a leach stage 210, a selective electrochemical copper removal stage 220, a precipitation stage 230 where iron and aluminum ions are removed, two solvent exchange stages 240 and 250 for removal of cobalt, manganese, and nickel, an ion exchange stage 260, and three salt splitters. As can be readily seen from FIG. 2, the plant is configured to operate in a closed process that receives black mass, and that produces various metal products in metallic form and lithium in a salt form at very high purities.

In the example of FIG. 2, lithium sulfate (or lithium methane sulfonate) can be provided to the front end of the process from the effluent of a salt splitting stage via stream 273. Here, lithium sulfate stream 273 along with recycled sulfuric acid (or MSA) 272 is fed to the leach stage 210, which may also include an anode and cathode assembly to reduce copper ions to metallic copper. The rich leach solution 216 can then be filtered in filter unit 215 to remove particulates, and especially graphite product 217. A portion of the rich leach solution 216 is returned to the leach stage 210 while the remaining rich leach solutions is then fed to precipitation stage 230 in which the solution is combined with the alkaline recycled lithium hydroxide solution 274′ that is provided from the second (and/or third) stage of the salt splitting cells 270. Advantageously, such recycling will not only preserve valuable lithium ions, but also obviate the need for external base to raise the pH in an amount that leads to precipitation of aluminum and iron ions in form of the corresponding hydroxides 232. The so produced precipitate can then be removed in a pressure filter 231 to so produce the further processed leach solution 234.

Further processed leach solution 234 is then fed to (three stage) solvent exchange unit 240 to remove cobalt and manganese and 250, and the effluent of the solvent exchange unit 240 is fed to solvent exchange unit 250 for selective removal of nickel. As can be seen from FIG. 2, some of the recycled lithium hydroxide stream 274′ may also be used in the solvent exchange unit 240, which once more preserves lithium in the process and which helps adjust the pH for the copper and manganese absorption. Moreover, it should be appreciated that the pH in the second stage of the solvent exchange unit 240 may be adjusted with sulfuric acid that is produced form within the process, and most preferably from the first and/or second salt splitter. The so cobalt- and manganese-enriched aqueous phase can then be fed to one or more Co/EMD electrolyzers 241 that form metallic cobalt and EMD (electrochemical manganese dioxide). Thus, it should be recognized that the process presented herein will advantageously not only allow for production of high purity lithium salts, but also for production of EMD and metallic cobalt, which are both significant components in lithium ion battery manufacture.

Solvent exchange unit 250 receives the aqueous effluent 244 of the solvent exchange unit 240 and is used for absorption and removal of nickel. Here, nickel is removed via selective solvent and ultimately plated in electrolyzer 251 to form metallic nickel 252. It should be appreciated that the aqueous effluent 254 of solvent exchange unit 250 is now enriched in lithium ions and depleted of copper, iron, aluminum, cobalt, manganese, and nickel. Any remining metal ions (other than lithium) can then be removed from the aqueous effluent 254 of solvent exchange unit 250 in an optional downstream ion exchange unit 260 (here: comprising three serially coupled ion exchange beds, which may have identical or different selectivity). After removal of non-lithium impurities in ion exchange unit 260, the lithium rich solution (typically containing lithium sulfate or lithium methane sulfonate) is fed to salt splitting cells 270 (here: three serially coupled cells) that will then produce sulfuric acid, lithium hydroxide, and an effluent.

In the example of FIG. 2, the first salt splitting cell 270A produces a concentrated pure sulfuric acid stream and a concentrated highly pure lithium hydroxide stream 271. As will be readily appreciated, the concentrated sulfuric acid is suitable for recycling within the process presented herein, and among other options, the sulfuric acid will be used as the acidifying reagent for the solvent exchange processes and/or electrolyte for the cobalt/EMD electrolyzers. The concentrated lithium hydroxide stream of the first salt splitting cell 270A can then be used in a lithium recovery unit 280 (that may be configured as a crystallizer) to produce a final lithium salt product 282.

The effluent of the first salt splitting cell 270A is then fed to a second salt splitting cell 270B, that once more produces a less pure and less concentrated stream of sulfuric acid 272 that is recycled back to the front end of the process as the leaching solution. Lithium hydroxide from the first salt splitting cell can be fed back upstream to the first salt splitting cell as is exemplarily shown in FIG. 2. The effluent of the second salt splitting cell 270B is fed to a third salt splitting cell 270C that produces another sulfuric acid stream (which is preferably fed back to the second salt splitting cell) and a lower purity lithium hydroxide stream 274′ that can be recycled back to the process (preferably to the solvent exchange unit and/or the precipitation stage as pH adjusting agent) to minimize losses of lithium. Finally, the effluent 273 of the third salt splitting cell 270C can be fed back to the leach unit or discarded as a metal depleted waste stream.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A method of recovering metals from disused lithium batteries in a closed-loop process in which an acidic leach solution is recycled, comprising:
leaching from a battery material a plurality of distinct metals in ionic form with the acidic leach solution to thereby produce a rich leach solution;
removing a first metal from the rich leach solution by electroplating to thereby produce a processed leach solution;
removing a second metal from the processed leach solution by precipitation to thereby produce a further processed leach solution;
removing a third and optionally fourth metal from the further processed leach solution by solvent exchange to thereby produce a third and optionally fourth metal depleted leach solution;
processing the third or optionally fourth metal depleted leach solution in a salt splitter unit to thereby regenerate at least some of the leach solution, to produce a metal hydroxide solution, and an effluent, wherein at least some of the metal hydroxide solution is used in the step of removing the second metal, and/or the step of removing a third and optionally fourth metal, and optionally wherein at least some of the effluent is used in the step of leaching.

2. The method of claim 1, wherein the battery material comprises black mass, and wherein the plurality of distinct metals include copper ions, aluminum ions, iron ions, cobalt ions, manganese ions, nickel ions, and lithium ions.

3. The method of claim 1, wherein the battery material comprises black mass, and wherein the plurality of distinct metals include copper ions, aluminum ions, iron ions, cobalt ions, manganese ions, and nickel ions, and wherein the black mass is a processed black mass from which lithium ions were previously removed.

4. The method of claim 1 any one of the preceding claims, wherein the leach solution is sulfuric acid or methane sulfonic acid, optionally containing a chelator.

5. The method of claim 1, wherein the first metal is copper, and wherein electroplating comprises preferential electroplating of copper onto a cathode.

6. The method of any claim 5, wherein the second metal is aluminum and/or iron.

7. The method of claim 6, wherein the third metal is cobalt and/or manganese.

8. The method of claim 7, wherein the cobalt and/or the manganese are recovered from an organic solvent of the solvent exchange using an acid, and wherein the copper and/or the manganese are plated as metallic copper and as EMD in a single electrolyzer.

9. The method of claim 7, wherein the solvent exchange uses a portion of the regenerated leach solution and/or the metal hydroxide solution from the salt splitter unit.

10. The method of claim 8, wherein the acid is recycled in the solvent exchange.

11. The method of claim 1, wherein the optional fourth metal is nickel and wherein the fourth metal is removed in a separate solvent exchange.

12. The method of claim 11, wherein the nickel is recovered from an organic solvent of the separate solvent exchange using an acid, and wherein the nickel is plated as metallic nickel in an electrolyzer.

13. The method of claim 11, wherein the separate solvent exchange uses a portion of the regenerated leach solution and/or the metal hydroxide solution from the salt splitter unit.

14. The method of claim 12, wherein the acid is recycled in the separate solvent exchange.

15. The method of claim 1, wherein the salt splitter unit comprises at least two salt splitters.

16. The method of claim 15, wherein a first portion of the metal hydroxide solution of one of the at least two salt splitters is further processed to produce a LiOH or LiOH·H₂O product or a lithium carbonate solution or a lithium carbonate precipitate.

17. The method of claim 15, wherein a second portion of the metal hydroxide solution is used in the step of removing the second metal, and/or wherein a second portion of the metal hydroxide solution is used in the step of removing the third and optionally fourth metal

18. (canceled)

19. The method of claim 1, further comprising using an ion exchange resin or chelating resin to remove metal ion impurities from the third and optionally fourth metal depleted leach solution before feeding the third and optionally fourth metal depleted leach solution into the salt splitter unit.

20. The method of claim 1, wherein the metal hydroxide solution is sodium hydroxide, potassium hydroxide, or calcium hydroxide when the battery material is at least partially depleted of lithium ions.

21. The method of claim 1, wherein the salt splitter unit is a bipolar electrodialysis unit.
